(19) United States
(12) Patent Application Publication
(10) Pub. No.: US 2017/0150370 A1
(43) Pub. Date: May 25, 2017

(54) Method, Device and System for Implementing Wireless Coverage

(71) Applicant: Beijing Xinwei Telecom Technology Inc., Beijing (CN)

(72) Inventors: Wenzhong ZHANG, Beijing (CN); Yuanchun TAN, Beijing (CN); Ruifeng XU, Beijing (CN); Wei ZHENG, Beijing (CN)

(21) Appl. No.: 15/309,500

(22) PCT Filed: Nov. 28, 2014
(86) PCT No.: PCT/CN2014/092438

§ 371 Date: Nov. 8, 2016

(30) Foreign Application Priority Data
Nov. 28, 2013 (CN) 201310625778.7

(51) Int. Cl. H04W 16/18; H04W 68/00; H04L 5/00; H04W 72/04

(52) U.S. Cl. CPC H04W 16/18; H04W 72/042; H04W 68/005; H04L 5/0048; H04L 5/0035; H04W 92/20

(57) ABSTRACT

Embodiments of the present disclosure provide a method for implementing wireless coverage, including: transmitting, at a local cell and an adjacent cell, a point-to-multipoint service using a Transmission Mode (TM) with a User Equipment (UE) reference signal; wherein the UE reference signal is generated using a same Identity (ID) and position mapping is performed for the UE reference signal using the same ID; transmission of the point-to-multipoint service is scrambled using the same ID.

This application claims the benefit of priority from a Chinese Patent Application, No. 201310625778.7, entitled “Method, device and server for implementing wireless coverage” and filed on Nov. 28, 2013, the entire content of which is hereby incorporated by reference.

### FIELD OF THE TECHNOLOGY

The present disclosure relates to a wireless communication field, and more particularly, to a method, device and system for implementing wireless coverage.

### BACKGROUND

The existing cluster communication uses a normal cellular coverage network. Since bandwidth of the Long Term Evolution (LTE) system is relatively wide, as for the LTE co-frequency networking, interference at the edge of a cell is serious, which leads to that capacity of cluster services of the LTE co-frequency networking is limited. The 3rd Generation Partnership Project (3GPP) is studying how to apply the Multimedia Broadcast Multicast Service (MBMS) mechanism to the cluster communication.

### SUMMARY

As to these problems above, an embodiment of the present disclosure provides a method for implementing wireless coverage, including:

simultaneously transmitting, at a local cell and an adjacent cell, a point-to-multipoint service using a Transmission Mode (TM) with the UE reference signal;

wherein the UE reference signal is generated using a same Identity (ID) and position mapping is performed for the UE reference signal using the same ID;

transmission of the point-to-multipoint service is scrambled using the same ID.

An embodiment of the present disclosure also provides a transmitting device, which transmits a point-to-multipoint service using a transmission mode with a UE reference signal; wherein the device uses transmission mode with UE reference signal to conduct point to multi-point service transmission, including:

a signal generating module, to generate the UE reference signal using a same Identity (ID);

a position mapping module, to perform position mapping for the UE reference signal using the same ID; and

a scrambling module, to scramble transmission of the point-to-multi-point service with the same ID.

An embodiment of the present disclosure also provides another method for implementing wireless coverage, includes:

receiving a point-to-multipoint service via receiving a User Equipment (UE) reference signal;

performing data reception processing using a Transmission Mode (TM) with the UE reference signal and a same Identity (ID);

wherein the same ID is same as that used to generate the UE reference signal.

An embodiment of the present disclosure also provides a receiving device, including:

a first module, to receive a UE reference signal; and

a second module, to perform data receiving processing using a same ID and a transmission mode with the UE reference signal; and

wherein the same ID is same as an ID used to generate the UE reference signal.

Finally, an embodiment of the present disclosure provides a system for implementing wireless coverage, which includes the transmitting device and the receiving device as described above.

According to the methods provided by the embodiments of the present disclosure, the local cell and the adjacent cell simultaneously transmit the point-to-multipoint service using the transmission mode with the UE reference signal. The UE reference signal is generated using a same ID, position mapping is performed for the UE reference signal using the same ID, and the transmission of the point-to-multipoint service is scrambled using the same ID. The above scheme may solve the problem of severe co-frequency cell edge interference and may not require the client to support the MBMS function.

### BRIEF DESCRIPTION OF THE DRAWINGS

To illustrate the technical solutions according to the embodiments of the present application more clearly, the accompanying drawings for describing the embodiments are introduced briefly in the following. The accompanying drawings in the following description are only some embodiments of the present disclosure; persons skilled in the art may obtain other drawings according to the accompanying drawings without paying any creative effort.

FIG. 1 is a diagram illustrating mapping between a downlink cell reference signal and a User Equipment (UE) reference signal in a Cyclic Prefix (CP) according to various embodiments of the present disclosure;

FIG. 2 is a diagram illustrating mapping between a downlink cell reference signal and a UE reference signal in an extended CP according to various embodiments of the present disclosure;

FIG. 3 is a diagram illustrating structure of a network according to various embodiments of the present disclosure;

FIG. 4 is a diagram illustrating structure of an MBMS network according to various embodiments of the present disclosure;

FIG. 5 is a diagram illustrating structure of a transmitting device according to various embodiments of the present disclosure; and

FIG. 6 is a diagram illustrating structure of a receiving device according to various embodiments of the present disclosure.

### DETAILED DESCRIPTIONS

In order to make the purpose, technical solution and merits of the present disclosure more clearer, in the following context, each technical solution of the present disclosure will be described in further detail with reference to accompanying drawings. It should be noted that technical features in each embodiment of the present disclosure may be arbitrarily combined with each other without conflict.

A problem of severe co-frequency cell edge interference may be solved with MBMS technologies. In order to using the MBMS technologies, a terminal may need to support an MBMS function. Terminals, which cannot support the MBMS function, cannot obtain MBMS-based cluster services. The present disclosure may disclose a method for implementing wireless coverage. The method may solve the above problem, but may not require the terminal to support the MBMS function.

Embodiments of the present disclosure may provide a method for implementing wireless coverage. In the method, a point-to-multi-point service may be simultaneously transmitted with a transmission mode with a UE reference signal at a local cell and an adjacent cell. The UE reference signal may be generated using a same Identity (ID) and position mapping may be performed for the UE reference signal using the same ID. The transmission of the point-to-multi-point service may be scrambled using the same ID. The receiving end may receive the UE reference signal, and perform data reception process for the UE reference signal using the same ID and transmission mode.

The method described above can use Transmission Mode (TM)7, TM8, TM9 or TM10 in the LTE.

### Embodiment One

The point-to-multipoint service may be transmitted using an antenna port 5 of the TM7.

In the LTE system, according to the protocol of 3GPP Technical Specification (TS) 36.211 V11.4.0 (2013-09), the UE reference signal and Physical-layer Cell Identity (PCI) may be related to a Radio Network Temporary Identity (RNTI), and a mapping position of the UE reference signal of the antenna port 5 may be related to the PCI, which may vary in different cells.

The method provided by embodiments of the present disclosure can be achieved by modifying the above UE reference. In order to make the generation of the UE reference signal and mapping of the pilot position of the UE reference signal irrelevant with the PCI, in the embodiments of the present disclosure, the UE reference signal may be generated and the pilot position of the UE reference signal may be mapped using another ID, as long as the ID may be the same in the local cell and the adjacent cell for the point-to-multipoint service. Therefore, the generation of the UE reference signal and the mapping of the pilot position of the UE reference signal may be the same in each cell.

For example, as for a cluster service, when a Group ID or Group Radio Network Temporary Identity (G-RNTI) of the local cell may be the same as that of the adjacent cell, the UE reference signal may be generated and polite position mapping may be performed for the UE reference signal of the Port5 using the Group ID or G-RNTI. Similarly, transmission of downlink services may be scrambled using the Group ID or G-RNTI. Thus, a downlink service may be simultaneously transmitted using the transmission mode with the UE reference signal in the local cell and the adjacent cell.

Taking into account the maximum use of existing standards, the Group ID or G-RNTI may be processed first as follows: make Group ID=Group ID mod 503, or G-RNTI=G-RNTI mod 503. Then, the UE reference signal may be generated and pilot position mapping may be performed for the UE reference signal of the Port5 using the Group ID or G-RNTI.

The UE reference signal of the Port5 may be generated using the following equation:

$${r}_{{n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 12 {N}_{RB}^{PDSCH} - 1$$

Wherein,

c(n)=(x₁(n+N_{C})+x₂(n+N_{C}))mod2

x₁(n+31)=(x₁(n+3)+x₁(n))mod2

x₂(n+31)=(x₂(n+3)+x₂(n+2)+x₂(n+1)+x₂(n))mod2

cᵢₙᵢₜ=(└nₛ/2┘+1)·(2n_{GRNTI}+1)·2¹⁶+n_{GRNTI}

or

cᵢₙᵢₜ=(└nₛ/2┘+1)·(2n_{GroupID}+1)·2¹⁶+n_{GroupID}

The pilot position mapping may be performed for the UE reference signal of the Port5 using the following equation:

a_{k,l}^{(p)}=rₙ_{ₛ}(3·l′·N_{RB}^{PDSCH}+m′)

Wherein,

$$\begin{matrix}k = ( {k}^{′} ) mod {N}_{sc}^{RB} + {N}_{sc}^{RB} \cdot {n}_{PRB} \\ {k}^{′} = \{ \begin{matrix}4 {m}^{′} + {v}_{shift} & if l ∈ \{ 2 , 3 \} \\ 4 {m}^{′} + ( 2 + {v}_{shift} ) mod 4 & if l ∈ \{ 5 , 6 \}\end{matrix} \\ l = \{ \begin{matrix}3 & {l}^{′} = 0 \\ 6 & {l}^{′} = 1 \\ 2 & {l}^{′} = 2 \\ 5 & {l}^{′} = 3\end{matrix} \\ {l}^{′} = \{ \begin{matrix}0 , 1 & if {n}_{s } mod 2 = 0 \\ 2 , 3 & if {n}_{s } mod 2 = 1\end{matrix} \\ {m}^{′} = 0 , 1 , … , 3 {N}_{RB}^{PDSCH} - 1 \\ {v}_{shift} = {n}_{GRNTI} mod 3 , or \\ {v}_{shift} = {n}_{GroupId} mod 3\end{matrix}$$

A bit stream of b^{(q)}(0), . . . , b^{(q)}(M_{bit}^{(q)}−1) may be allocated to (codeword) q of a Physical Downlink Control Channel (PDCCH). Wherein, M_{bit}^{(q)} may be bit number of (codeword) q. A scrambling equation of (codeword) q may be as follows:

\tilde{b}^{(q)}(i)=(b^{(q)}(i)+c^{(q)}(i))mod2

Wherein:

cᵢₙᵢₜ=n_{GRNTI}·2¹⁴+q·2¹³+└nₛ/2┘·2⁹+n_{GRNTI}

or

cᵢₙᵢₜ=n_{GroupId}·2¹⁴+q·2¹³+└nₛ/2┘·2⁹+n_{GroupId}

Air Interface Analysis:

Referring to FIG. 1, distribution of a Cell Reference Signal (Cell_RS) and a UE Reference Signal (UE_RS) of two cells in the co-frequency networking may be shown in FIG. 1 (PCIs of the two cells may be configured as 0 and 1). Wherein, si may represent an Orthogonal Frequency Division Multiplexing (OFDM) symbol i. Physical Downlink Shared Channel (PDSCH) may be transmitted on symbol 3 (s3) to symbol 13 (s13). On symbol 4 (s4), symbol 7 (s7) and symbol 11 (s11), there may be interferences on the local cell from an adjacent cell. Remaining symbols can obtain diversity gain of the adjacent cell.

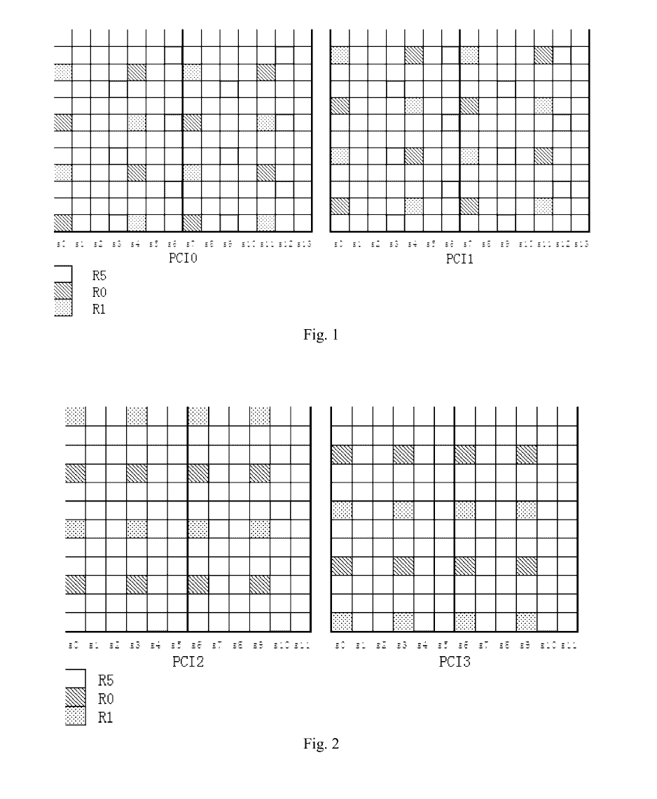

Similarly, referring to FIG. 2, the PDSCH may be transmitted on symbol 2(s2) to symbol 11 (s11). On symbol 3 (s3), symbol 6 (s6) and symbol 9 (s9), there may be interferences on the local cell from an adjacent cell. The remaining symbols can obtain diversity gain of the adjacent cell.

Therefore, the coverage performance of the method provided by embodiments of the present disclosure may be better than that of the method provided by the conventional cell.

### Embodiment Two

The point-to-multipoint data may be transmitted using an antenna port 7 of TM8/TM9/TM10. Sequence of the antenna port 7 may be generated using the following equation:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix} \qquad □$$

wherein:

cᵢₙᵢₜ=(└nₛ/2┘+1)·(2n_{GRNTI}⁽ⁿ^{_{SCID}}⁾+1)·2¹⁶+n_{SCID}

or

cᵢₙᵢₜ=(└nₛ/2┘+1)·(2n_{GroupId}⁽ⁿ^{_{SCID}}⁾+1)·2¹⁶+n_{SCID}

A frequency domain mapping equation of the antenna port 7 may remain the same:

PDSCH Scrambling

\tilde{b}^{(q)}(i)=(b^{(q)}(i)+c^{(q)}(i))mod2

cᵢₙᵢₜ=n_{GRNTI}·2¹⁴+q·2¹³+└nₛ/2┘·2⁹+n_{GRNTI}

or

cᵢₙᵢₜ=n_{GroupId}·2¹⁴+q·2¹³+└nₛ/2′·2⁹+n_{GroupId}

For a point-to-multipoint service, the receiving end may receive a UE reference signal, and perform data reception process for the UE reference signal using the same ID and transmission mode. Wherein, the same ID may be the Group ID or G-RNTI or a function of the Group ID or G-RNTI. The receiving end may receive cluster paging to obtain a cluster Group ID or G-RNTI of the receiving end. In the embodiments of the disclosure, the same ID may be the same as that used to generate the UE reference signal.

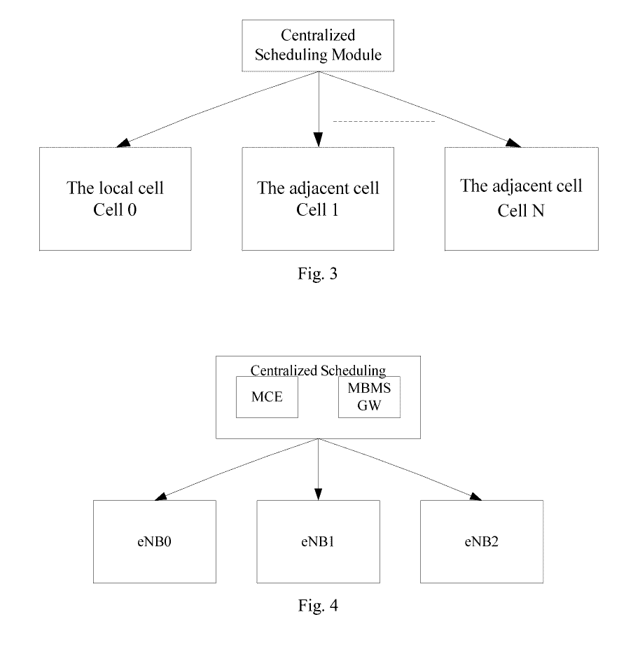

Referring to FIG. 3, the network side may use a centralized scheduling module to schedule and control services of cells controlled by the network side. Wherein, the centralized scheduling module may perform transmission for the local cell0 using a transmission mode with the UE reference signal. The UE reference signals may be generated using the same ID and position mapping may be performed for the UE reference signal using the same ID. Transmission of a downlink service may be scrambled with the same ID.

For example, in a Multimedia Broadcast Multicast Service (MBMS) architecture, referring to FIG. 4, the centralized scheduling module may include a Multi-cell/Multicast Coordination Entity (MCE) and an MBMS GateWay (GW), which may control co-frequency base stations of eNB0, eNB1 and eNB2. Neighbor cells of the eNB0 may include an eNB1 and an eNB2.

When a cluster group call service establishes the MBMS area, transmission may be performed using a Space Frequency Block Code (SFBC) transmission scheme of the LTE transmission mode TM7. The centralized scheduling module may perform the transmission for the local cell, i.e., eNB0 and adjacent cells, i.e., eNB1 and eNB2 using a transmission mode with the UE reference signal. Using this service, the UE reference signal may be generated in each cell using a same parameter, i.e., G-RNTI. Physical scrambling may be performed for the transmission of the cluster services using the G-RNTI. The cluster group call service may be scheduled on the MCE. Data may be transmitted using a SYNC protocol. Data may be transmitted on a physical shared channel.

The local cell and the adjacent cell in the above methods can be two physically adjacent cells or logically adjacent cells (determined using an index factor, such as signal strength, but may not be geographically adjacent cells). The local cell and the adjacent cell may be located at different sectors of a same base station, or may belong to different base stations. Then, relevant data of the point-to-multipoint service may be transmitted among cells via X2 interfaces between base stations. The relevant data of the point-to-multipoint service may include: scheduling information of the service (such as number of allocated Resource Blocks (RB)s and positions thereof, MCS, etc.) and data of the service.

In the above methods, Group ID and G-RNTI can be issued via cluster paging or broadcasting. The UE reference signal, the cell reference signal and the point-to-multipoint service may be issued using a broadcast weight value.

### Embodiment Three

An embodiment of the present disclosure may also provide a transmitting device to achieve the method above. The device may transmit a point-to-multipoint service with a transmission mode with the UE reference signal. The device may include:

a signal generating module, configured to generate the UE reference signal using a same Identity (ID);

a position mapping module, configured to perform position mapping for the UE reference signal using the same ID; and

a scrambling module, configured to scramble transmission of the point-to-multi-point service with the same ID.

The TM with the UE reference signal may include a TM7, a TM8, a TM9 or a TM10 of Long Term Evolution (LTE).

Further, the device may further include: an ID module. When the point-to-multipoint service is a cluster service, and a Group ID of the cluster service or a Group Radio Network Temporary Identity (G-RNTI) of the local cell is the same as that in the adjacent cell, the ID module may be configured to take the Group ID or the G-RNTI or a function of the Group ID or the G-RNTI as the same ID. The device may further include a transmitting module, configured to issue the UE reference signal and the point-to-multipoint service using a broadcasting weight value and issue the Group ID or G-RNTI using cluster paging.

### Embodiment Four

An embodiment of the present disclosure may further provide a receiving device for implementing the above method. The device may include:

a first module, configured to receive a User Equipment (UE) reference signal;

a second module, configured to perform data reception processing using a Transmission Mode (TM) with the UE reference signal and a same Identity (ID);

wherein the same ID may the same as that used to generate the UE reference signal.

The same ID may be a Group ID or G-RNTI or a function of the Group ID or G-RNTI.

The device may further include a third module, configured to obtain the Group ID or G-RNTI via cluster paging.

### Embodiment Five

An embodiment of the present disclosure may further provide a system for implementing wireless coverage. The system may include the transmitting device as described in the embodiment three and the receiving device as described in the embodiment four.

Through the above specific embodiments, it can be seen that technical solution provided by the embodiments of the present disclosure can solve serious problem of severe cell edge interference, but may not require the client to support the MBMS function.

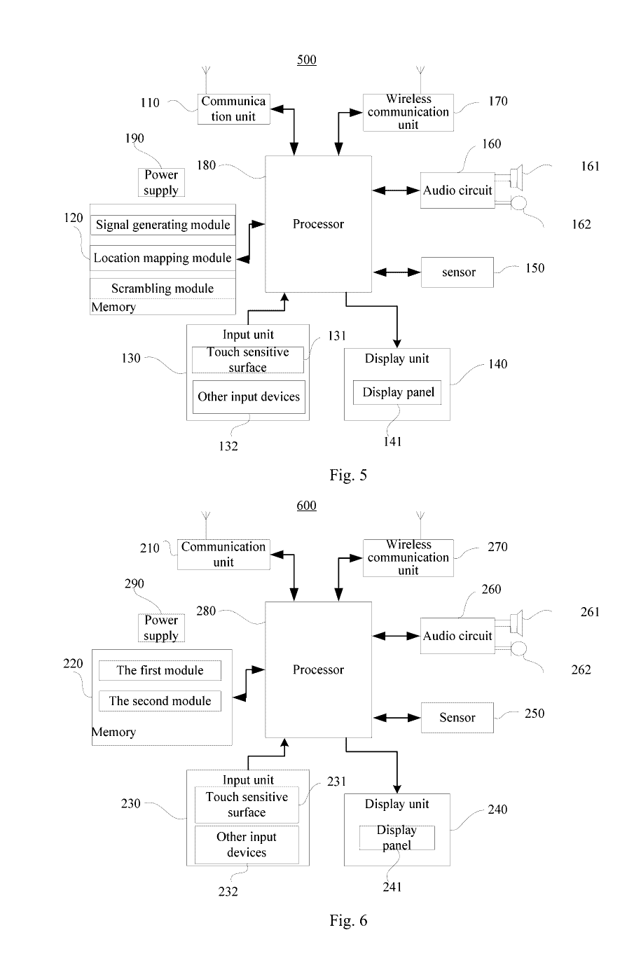

FIG. 5 is a schematic diagram illustrating structure of a transmitting device according to embodiments of the present disclosure. Referring to FIG. 5, the transmitting device may be used to implement the service transmission methods provided in the above embodiments.

The transmitting device 500 can include a communication unit 110, a memory 120 including one or more machine-readable storage media, an input unit 130, a display unit 140, a sensor 150, an audio circuit 160, a wireless communication module 170, a processor 180 including one or more processing cores, a power supply 190, and/or other components. The wireless communication module 170 may be a WiFi module. It may be well known to an ordinary skilled in the art of the present disclosure that the structure of the transmitting device shown in FIG. 5 cannot limit the terminal device in embodiments of the present disclosure. The transmitting devices in the embodiments of the present disclosure may include more or less components than those in FIG. 5. In another example, the transmitting device in embodiments of the present disclosure may consist of combination of some components or different component layouts.

The communication unit 110 may be used to send and receive information or receive and transmit signals during a call. The communication unit 110 may be a network communication device, such as a Radio Frequency (RF) circuit, router, modem, etc. Particularly, when the communication unit 110 may be an RF circuit, after receiving the downlink information of the base station, it may be handed over to the one or more processors 180 to treat. In addition, the data related to uplink transmission may be sent to the base station. Typically, as a communication unit, the RF circuit may include but may not be limited to an antenna, at least one amplifier and a tuner, one or more oscillators, a Subscriber Identity Module (SIM) card, a transceiver, a coupler, Low Noise Amplifier (LNA), a duplexer, etc. In addition, the communication unit 110 may also communicate with other devices by the wireless communication and network. The wireless communication may use any communication standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), e-mail, Short Messaging Service (SMS).

The memory 120 can be used to store software programs and modules, processors 180 running software programs and modules stored in the memory 120 to perform a variety of function applications and data processing. Memory 120 may mainly include: a program storage area and a data storage area. Wherein, the program storage area can store the operating system, the application desired by at least one function (such as a sound playback function, image playback function, etc.). Data storage area may store the data that created according to the using of transmission device 500 (such as audio data, phone book, etc.) In addition, the memory 120 may include high-speed random access memory and may include nonvolatile memory, such as at least one disk storage devices, flash memory devices, or other volatile solid-state memory devices. Accordingly, the memory 120 may also include a memory controller to provide the access to the memory 120 by the processor 180 and input unit 130. In the embodiment of the present disclosure, the memory 120 may be used to store the signal generating module, the position mapping module and scrambling module.

The input unit 130 may be used to receive the entered number or character information, and to generate signal input of keyboard, mouse, operating lever, optical or trackball, and the signal input may be related to user settings and function control. Specifically, the input unit 130 may include: the touch sensitive surface 131, and other input devices 132. Touch sensitive surface 131, may be also known as touch screen or track pad, can collect the touch operation on or near it (for example, the operation of user using a finger, a stylus and any other suitable object or accessory on the touch sensitive surface 131 or near the touch-sensitive surface 131), and can drive the corresponding connection device according to a preset program. Touch sensitive surface 131 may include two parts: touch detection device and touch controller. Wherein, the touch detection device detects the user's touch position and the signal brought by touch operation, and transmits the signal to the touch controller. Touch controller may receive touch information from the touch detection device and convert it into contact coordinates, then send to the processor 180, and the touch controller can receive commands sent by the processor 180 and implement them. In addition, it can use resistive, capacitive, infrared and surface acoustic wave, and other type to implement touch sensitive surface 131. In addition to touch sensitive surface 131, input unit 130 may also include other input devices 132. In particular, other input devices 132 may include, but be not limited to one or more than one of the following types: physical keyboard, function keys (such as volume control buttons, switches keys, etc.), track balls, mice, levers and so on.

The display unit 140 may be used to display information input by the user, or information provided to the user, and various graphical user interfaces of transmitting device 500. The graphical user interface may be formed by graphics, text, icons, video, and any combination thereof. The display unit 140 may include the display panel 141, Liquid Crystal Display (LCD), Organic Light-Emitting Diode (OLED) and other form may be employed to configure the display panel 141. Further, the touch-sensitive surface 131 may cover the display panel 141, when the touch sensitive surface 131 detects touch operation on or near it, the touch operation may be transmitted to the processor 180 to determine the type of touch event, then processor 180 provides relevant visual output on the display panel 141 according to the touch event type. Although in FIG. 5, the touch sensitive surface 131 and the display panel 141 may be taken as two separate components to achieve the input and output functions, in some embodiments, touch sensitive surface 131 and the display panel 141 may be integrated to achieve input and output functions.

Sensor 150 may include: a light sensor, a motion sensor, and other sensors. Optical sensors may include: the ambient light sensor and proximity sensor. Wherein, the ambient light sensor may adjust the brightness of the display panel 141 according to the ambient light's brightness. The proximity sensor may close the display panel 141 and/or backlighting when sending device 500 may be moved to the ear. As a motion sensor, gravity sensor can detect the size of acceleration in all directions (usually triaxial). The size and direction of gravity can be detected when it is still, which can be used to identify the phone gesture (such as horizontal and vertical screen switch, the relevant game, attitude magnetometer calibration), to achieve vibration recognition related functions (such as pedometer, percussion) and the like. Sending device 500 can also configure gyroscope, barometer, hygrometer, thermometer, the infrared sensor and other sensor devices.

Audio circuit 160, speaker 161, microphone 162 may provide the audio interface between user and transmission device 500. Audio circuit 160 may convert received audio data to, and transmit the converted electrical signal to the speaker 161, then the speaker 161 may convert electrical signal to sound signal and output it. On the other hand, the microphone 162 may convert sound signal that collected into electrical signals, which may be received by the audio circuit 160 and may be converted into audio data, then after processed by processor 180, the audio data may be sent by the RF circuit 110 to the receiving device, or may be output to the memory 120 for further processing. The audio circuit 160 may also include: headset jack, which may provide the communication between peripherals headphones and transmission device.

The wireless communication unit 170 may be a WiFi module. WiFi may belong to short-range wireless transmission technology. Users can take advantage of the wireless communication unit 170 to send and receive e-mail, browse the Web and access streaming media and so on. The wireless communication unit 170 may provide users with wireless broadband Internet access function. Although FIG. 5 shows the wireless communication unit 170, in specific applications, the transmission device 500 may not include the wireless communication unit 170.

Processor 180 may be the control center of transmitting device 500. The processor 180 may use a variety of interfaces and lines to connect to the various parts of the entire mobile phone, it may perform each function and process data of transmission device 500 so as to monitor transmitting device 500 overall by running or executing software program or module stored in the memory 120, and by calling data stored in the memory 120. Processor 180 may include one or more processing cores. Processor 180 may be integrated application processor and modem processor. Wherein, the application processor may mainly process operating system, user interface and applications, and the modem processor may mainly deal with wireless communications. It may be appreciated that the processor 180 above may also not include the modem processor.

The power supply 190 may be connected with processor 180 logically through a power management system, so it can achieve charging, discharge and power management functions through power management system. The power supply 190 may also include one or more than one Direct Current (DC) or Alternating Current (AC) power, recharging system, power malfunction detection circuit, a power converter or inverter, power status indicators and any other part.

Although not shown in the context above, the transmission device 500 may also include a camera, Bluetooth module, not repeat them here. In the embodiment of present disclosure, the display unit of transmitting device may be a touch screen display. One or more programs may be stored in the memory 120, and may be configured so as to be performed by one or more processors 180. The one or more programs contain instructions for performing the following operations:

simultaneously transmitting, at a local cell and an adjacent cell, a point-to-multipoint service using a Transmission Mode (TM) with a User Equipment (UE) reference signal;

wherein the UE reference signal is generated using a same Identity (ID) and position mapping is performed for the UE reference signal using the same ID;

transmission of the point-to-multipoint service is scrambled using the same ID.

FIG. 6 is a diagram illustrating structure of a receiving device according to various embodiments of the present disclosure. The receiving device 600 may include: a communication unit 210, which may include one or more than one non-volatile computer-readable storage medium memory 220, an input unit 230, a display unit 240, a sensor 250, an audio circuit 260, a wireless communication unit 270, one or more than one processing core processor 280, a power supply 290 and other components.

The input unit 230 may include: a touch sensitive surface 231, and other input devices 232. The display unit 240 may include a display panel 241. The audio circuit 260 may include: a speaker 261 and a microphone 262.

The communication unit 210, memory 220, input unit 230, display unit 240, sensor 250, audio circuit 260, wireless communication unit 270, one or more than one processing core processor 280, power supply 290, touch sensitive surface 231, other input devices 232, display panel 241, speaker 261, and microphone 262 may be respectively the same as the communication unit 110, memory 120, input unit 130, display unit 140, sensor 150, audio circuit 160, wireless communication unit 170, one or more than one processing core processor 180, power supply 190, touch sensitive surface 131, other input devices 132, display panel 141, speaker 161 and the microphone 162, which may not be repeated here.

The memory 220 may include: a first module and a second module, which may be configured so as to be performed by the one or more processors 280. The one or more programs contain instructions for performing the following operations:

receiving a point-to-multipoint service via receiving a User Equipment (UE) reference signal;

performing data reception processing using a Transmission Mode (TM) with the UE reference signal and a same Identity (ID);

wherein the same ID is same as that used to generate the UE reference signal.

The embodiments above are merely part of the embodiments of the present disclosure, but not all the embodiments. Under the premise that those ordinary skill staff do not make creative work, any modification, equivalent replacements or improvements within the spirit and principles of the present disclosure, shall fall within the protection range of the present disclosure.

1. A method for implementing wireless coverage, comprising:
generating a User Equipment (UE) reference signal using a same Identity (ID);
performing position mapping for the UE reference signal using the same ID;
transmitting, at a local cell and an adjacent cell, a point-to-multipoint service using a Transmission Mode (TM) with a User Equipment (UE) reference signal;
wherein the transmission of the point-to-multipoint service is scrambled using the same ID.

2. The method according to claim 1, wherein, the TM with the UE reference signal comprises: a TM7, a TM8, a TM9 or a TM10 of Long Term Evolution (LTE).

3. The method according to claim 1, wherein, when the point-to-multipoint service is a cluster service, and a Group ID of the cluster service or a Group Radio Network Temporary Identity (G-RNTI) of the local cell is the same as that in the adjacent cell, the same ID is the Group ID or G-RNTI or a function of the Group ID or G-RNTI.

4. (canceled)

5. The method according to claim 3, wherein, the UE reference signal is generated using a following equation:
$${r}_{{n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 12 {N}_{RB}^{PDSCH} - 1$$
wherein,
cᵢₙᵢₜ=(└nₛ/2┘+1)·(2n_{GRNTI}+1)·2¹⁶+n_{GRNTI}
or
cᵢₙᵢₜ=(└nₛ/2┘+1)·(2n_{GroupId}+1)·2¹⁶+n_{GroupId}
the position mapping of the UE reference signal adopts a following equation:
a_{k,l}^{(p)}=rₙ_{ₛ}(3·l′·N_{RB}^{PDSCH}+m′)
wherein,
$$\begin{matrix}k = ( {k}^{′} ) {mod N}_{sc}^{RB} + {N}_{sc}^{RB} \cdot {n}_{PRB} \\ {k}^{′} = \{ \begin{matrix}4 {m}^{′} + {v}_{shift} & if l ∈ \{ 2 , 3 \} \\ 4 {m}^{′} + ( 2 + {v}_{shift} ) mod 4 & if l ∈ \{ 5 , 6 \}\end{matrix} \\ l = \{ \begin{matrix}3 & {l}^{′} = 0 \\ 6 & {l}^{′} = 1 \\ 2 & {l}^{′} = 2 \\ 5 & {l}^{′} = 3\end{matrix} \\ {l}^{′} = \{ \begin{matrix}0 , 1 & if {n}_{s } mod 2 = 0 \\ 2 , 3 & if {n}_{s} mod 2 = 1\end{matrix} \\ {m}^{′} = 0 , 1 , … , 3 {N}_{RB}^{PDSCH} - 1 \\ {v}_{shift} = {n}_{GRNTI } mod 3 , or \\ {v}_{shift} = {n}_{GroupId } mod 3\end{matrix}$$
a (codeword) q is scrambled using a following equation:
\tilde{b}^{(q)}(i)=(b^{(q)}(i)+c^{(q)}(i))mod2
wherein,
cᵢₙᵢₜ=n_{GRNTI}·2¹⁴+q·2¹³+└nₛ/2┘·2⁹+n_{GRNTI}
or
cᵢₙᵢₜ=n_{GroupId}·2¹⁴+q·2¹³+└nₛ/2┘·2⁹+n_{GroupId}.

6. The method according to claim 3, wherein the UE reference signal is generated using a following equation:
$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix} \qquad □$$
wherein:
cᵢₙᵢₜ=(└nₛ/2┘+1)·(2n_{GRNTI}⁽ⁿ^{_{SCID}}⁾+1)·2¹⁶+n_{SCID}
or
cᵢₙᵢₜ=(└nₛ/2┘+1)·(2n_{GroupId}⁽ⁿ^{_{SCID}}⁾+1)·2¹⁶+n_{SCID}
the position mapping for the UE reference signal adopts a frequency domain mapping equation of an antenna port 7 of TM8/TM9/TM10 of the LTE;
a (codeword) q is scrambled using a following equation:
\tilde{b}^{(q)}(i)=(b^{(q)}(i)+c^{(q)}(i))mod2
cᵢₙᵢₜ=n_{GRNTI}·2¹⁴+q·2¹³+└nₛ/2┘·2⁹+n_{GRNTI}
or
cᵢₙᵢₜ=n_{GroupId}·2¹⁴+q·2¹³+└nₛ/2┘·2⁹+n_{GroupId}.

7. The method according to claim 3, wherein the Group ID or G-RNTI is issued via cluster paging.

8. The method according to claim 1, wherein the UE reference signal and the point to multipoint service are issued using a broadcasting weight value.

9. (canceled)

10. The method according to claim 1, wherein the point-to-multipoint service is transmitted on a Physical Downlink Shared Channel (PDSCH).

11. (canceled)

12. The method according to claim 1, wherein the point to multipoint service is centrally scheduled via an upper-layer Network Element (NE).

13. The method according to claim 1, wherein when the local cell and the adjacent cells are located at different base stations, scheduling information and service data of the point-to-multipoint service is transmitted via an X2 interface.

14. The method according to claim 1, wherein, the local cell and the adjacent cells are located at different sectors of a same base station.

15. A transmitting device, wherein the device transmits a point-to-multi-point service using a Transmission Mode (TM) with a UE reference signal and comprises: a signal generating module, a position mapping module and a scrambling module;
the signal generating module, is to generate the UE reference signal using a same Identity (ID);
the position mapping module, is to perform position mapping for the UE reference signal using the same ID; and
the scrambling module, is to scramble transmission of the point-to-multi-point service with the same ID.

16. The device according to claim 12, wherein the TM with the UE reference signal comprises: a TM7, a TM8, a TM9 or a TM10 of Long Term Evolution (LTE).

17. The device according to claim 12, further comprising: an ID module;
wherein when the point-to-multipoint service is a cluster service, and a Group ID of the cluster service or a Group Radio Network Temporary Identity (G-RNTI) of the local cell is the same as that in the adjacent cell, the ID module is to take the Group ID or the G-RNTI or a function of the Group ID or the G-RNTI as the same ID.

18. The device according to claim 12, further comprising:
a transmitting module, to issue the UE reference signal and the point-to-multipoint service using a broadcasting weight value and issue the Group ID or G-RNTI using cluster paging.

19. A method for implementing wireless coverage, comprising:
receiving a point-to-multipoint service via receiving a User Equipment (UE) reference signal;
performing data reception processing using a Transmission Mode (TM) with the UE reference signal and a same Identity (ID);
wherein the same ID is same as that used to generate the UE reference signal.

20. The method according to claim 16, wherein the same ID is a Group ID, a G-RNTI, or a function of the G-RNTI or the Group ID.

21. The method according to claim 17, further comprising:
obtaining the Group ID or G-RNTI using cluster paging.

22. A receiving device, comprising: a first module and a second module, wherein
the first module, is to receive a User Equipment (UE) reference signal;
the second module, is to perform data reception processing using a Transmission Mode (TM) with the UE reference signal and a same Identity (ID);
wherein the same ID is the same as that used to generate the UE reference signal.

23. (canceled)

24. The device according to claim 19, further comprising: a third module, to obtain the Group ID or G-RNTI via cluster paging.

25. (canceled)
